(19) United States
(12) Patent Application Publication
(10) Pub. No.: US 2012/0247580 A1
(43) Pub. Date: Oct. 4, 2012

(54) Apparatus and a System for Dispersing Water from a Downspout

(76) Inventor: Clifford Guinyard, (US)

(21) Appl. No.: 13/075,175

(22) Filed: Mar. 29, 2011

(51) Int. Cl. F16L 5/00; F16L 11/00; F16L 33/00

(52) U.S. Cl. 137/357; 285/238; 138/109

(57) ABSTRACT

An apparatus and a system includes a fluid duct comprising a first portion having an open end and a second portion having a closed end where the first portion and the second portion form an angle. The fluid duct is configured for joining the open end to a downspout. A hose connector comprises a hollow passage way and a threaded exterior portion. The hose connector is joined to the second portion proximate the closed end where the hose connector forms a passage to an interior of the fluid duct enabling fluid in the fluid duct to pass to an exterior of the hose connector. A hose is removably joined to the threaded exterior portion of the hose connector for dispersing the fluid away from the hose connector above a ground surface.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to devices for distributing water from a downspout. More particularly, the invention relates to an attachment device for a downspout for dispersing water from the downspout to a remote location.

### BACKGROUND OF THE INVENTION

Water flowing through a downspout tends to wash away the ground at or near the downspout exit, thereby creating pools of water adjacent to the building foundation. Standing water near a building or structure can cause deterioration and seeping problems in the foundation and base structures of the building or structure. It is therefore an objective of the present invention to provide means to disperse water from a downspout at a location remote from the building or structure to which the downspout is attached, preferably at a substantial distance from the building or structure.

Various means for dispersing water from a downspout have been disclosed in the prior art. One such device is a flexible water dispersion device that may be attached to a downspout and comprises a coiled tube having a plurality of openings formed in the tube surface. A flat spring band extends through the body of the tube as a coiling mechanism. To disperse water from the downspout, the water dispersion device requires the development of sufficient water pressure to uncoil the tube, which is normally coiled. However, it is preferred that a downspout water dispersing means should also be operable at a low-pressure head. Another prior art water dispersion device is a downspout attachment tube having coiling means disposed in channels formed on opposing sides of the tube. Similar to the previously described prior art device, apertures are formed in the tube to disperse downspout water in the present device. The dispersion of downspout water through the apertures formed along the length of the flexible water dispersing tubes in these prior art devices is a limitation. It is preferable to provide means to distribute the water at a remote location away from the downspout in order to generally eliminate the previously noted pooling problems near the building or structure to which the downspout is attached.

There are some prior art devices for remote dispersion of water from a downspout. These devices include a downspout attachment assembly with a remote water receiver and an articulated downspout. The downspout attachment assembly generally comprises a substantially hollow water receiver remotely disposed from a downspout and connected to the lower end of the downspout via a conduit. The conduit is buried below the ground, and the water receiver is buried in the ground having its upper end substantially flush with the ground surface. This assembly is not readily adaptable to a downspout without substantial excavation. Furthermore, the static position of the water receiver can result in the formation of pools of water adjacent to the receiver, which may tend to wash the ground away near the remote receiver. The articulated downspout comprises an upper fluid duct and a lower fluid duct pivotally attached to the lower end of the upper fluid duct. The lower fluid duct is typically disposed in an upright position adjacent to the upper fluid duct. To disperse water from the downspout, the lower fluid duct is released to pivot downward by water pressure acting on a release mechanism disposed in the upper fluid duct. It is preferred that a water dispersion device be readily attachable to a downspout in a non-obtrusive manner; however, these prior art water dispersion downspout assemblies generally require special construction for adaptation to existing downspouts.

Another prior art water dispersing device comprises a flow diverter in a downspout to selectively disperse downspout water through a sidewall of the downspout for water collection. It should be noted that all of the heretofore described downspout water dispersion devices distribute the water from the downspout to a static location, whether remote from the downspout or adjacent thereto. Therefore, water dispersed from the downspout may tend to wash away the ground and thereby create pools near where the water is released. It is therefore an objective of the present invention to provide a downspout water dispersion device that permits distribution of downspout water at a variety of remote locations as selected by the user to generally eliminate the development of pools of water where the water is distributed.

For ease of use and assembly, readily available materials such as, but not limited to, a garden hose are preferably used as elements of a downspout water dispersion device. Several advantages result from the use of a conventional garden hose as downspout water dispersion means. Firstly, most homeowners already own a water hose and water hoses are widely available for purchase. Secondly, the use of a long, flexible water hose permits the selective dispersion of downspout water to a wide variety of remote locations. Water hose connectors in a downspout are shown in the prior art for connection of a conventional water hose to supply water for flushing a downspout or gutter; however, no disclosure or suggestion is shown in the prior art for use of a conventional water hose as a downspout water dispersion means.

In view of the foregoing, there is a need for improved techniques for providing downspout water dispersion means that disperses water away from the downspout, enables a user to choose from a multiplicity of water dispersion locations, is easy to install, and uses readily available materials.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate an exemplary downspout attachable water-dispersing device, in accordance with an embodiment of the present invention. FIG. 1A is a front perspective view, and FIG. 1B is a diagrammatic side view;

FIG. 2 is a front perspective view of an exemplary downspout attachable water-dispersing device attached to a downspout and a conventional water hose, in accordance with an embodiment of the present invention;

FIG. 3 is a diagrammatic side view of an exemplary right angle, downspout attachable water-dispersing device, in accordance with an embodiment of the present invention;

FIG. 4 is a diagrammatic side view of an exemplary downspout attachable water-dispersing device, in accordance with an embodiment of the present invention; and

FIG. 5 is a side perspective partially cut away view of an exemplary downspout attachable water-dispersing device, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus and a system for dispersing water from a downspout is presented.

In one embodiment an apparatus includes a fluid duct comprising a first portion having an open end and a second portion having a closed end where the first portion and the second portion form an angle. The fluid duct is configured for joining the open end to a downspout. A hose connector comprises a hollow passage way. The hose connector is joined to the second portion proximate the closed end where the hose connector forms a passage to an interior of the fluid duct enabling fluid in the fluid duct to pass to an exterior of the hose connector.

In another embodiment an apparatus includes means for joining to a downspout to disperse a fluid from the downspout and means for joining to a hose to enable fluid to pass from the means for joining to a downspout to the hose.

In another embodiment a system includes a fluid duct comprising a first portion having an open end and a second portion having a closed end where the first portion and the second portion form an angle. The fluid duct is configured for joining the open end to a downspout. A hose connector comprises a hollow passage way and a threaded exterior portion. The hose connector is joined to the second portion proximate the closed end where the hose connector forms a passage to an interior of the fluid duct enabling fluid in the fluid duct to pass to an exterior of the hose connector. A hose is removably joined to the threaded exterior portion of the hose connector for dispersing the fluid away from the hose connector above a ground surface.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A preferred embodiment of the present invention and at least some variations thereof provide a downspout attachable water-dispersing device that generally comprises an obtuse-angled fluid duct having an open upper end attachable to an end of a downspout and a closed lower end having a water hose connector disposed therein in communication with the interior of the fluid duct. Many preferred embodiments enable different type of water dispersion means to be attached to the water-dispersing device such as, but not limited to, a conventional water hose or a water hose having a plurality of sidewall dispersion orifices formed near the distally extending end of the hose. Many preferred embodiments permit dispersion of water from a downspout at a variety of locations that are remote from the downspout and are preferably selected by a user. Many preferred embodiments can be economically manufactured and are inexpensive to purchase. Furthermore, many preferred embodiments are readily adaptable to existing downspouts.

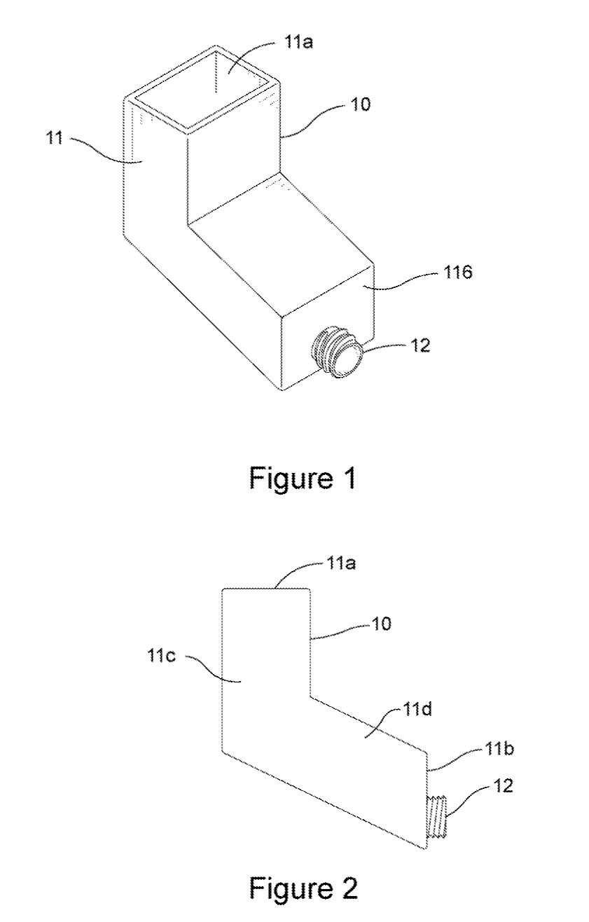

FIGS. 1A and 1B illustrate an exemplary downspout attachable water-dispersing device 10, in accordance with an embodiment of the present invention. FIG. 1A is a front perspective view, and FIG. 1B is a diagrammatic side view. In the present embodiment, downspout attachable water-dispersing device 10 generally comprises an obtuse-angled fluid duct 11 having an open upper end 11a and a closed lower end 11b. A water hose connector 12 is disposed in lower end 11b of fluid duct 11. Upper end 11a of fluid duct 11 is shaped to attach to a lower end of a downspout. Water hose connector 12 communicates with the hollow interior of fluid duct 11. Water from the downspout is dispersed from fluid duct 11 through water hose connector 12, and a water dispersion means connected to water hose connector 12 carries the water to a location that is remote from the downspout. Various different water dispersion means may be connected to water hose connector 12 including, without limitation, a conventional water hose, a hose specifically designed to be used with water-dispersing device 10, a rigid tube, etc. In the present embodiment, water hose connector 12 is a male connector; however, female connectors may be used in alternate embodiments.

Referring to FIG. 1B, fluid duct 11 substantially comprises a vertically disposed downspout attachment section 11c and a water hose connector section 11d angularly disposed from downspout attachment section 11c. Water hose connector section 11d is preferably disposed at substantially 115 degrees from downspout attachment section 11c to facilitate water flow and attachment of water dispersion means to water hose connector section 11d; however, the water hose connector section may be disposed at different angles in alternate embodiments. In the present embodiment, water hose connector 12 is preferably oriented parallel to water hose connector section 11d and preferably is disposed below the horizontal mid-line of lower end 11b. The orientation of sections 11c and 11d of fluid duct 11 and water hose connector 12 generally provides a free-flowing fluid duct 11 and easy water hose attachment to downspout attachment water-dispersing device 10. However, the orientation of these elements in alternate embodiments may vary. For example, without limitation, the water hose connector in some alternate embodiments may not be in a parallel orientation to the water hose connector section.

An exemplary method for constructing water-dispersing device 10 is described in the following. This method uses attachment means such as, but not limited to, bolts or screws. However, those skilled in the art, in light of the present teachings will readily recognize that various different types of construction methods may also be used such as, but not limited to, welding, adhering, injection molding, extruding, etc. Using the present construction method, fluid duct 11 and lower end 11b may be formed from flat sheets of material by die-cutting, stamping or the like. A central opening is formed in lower end 11b for receipt of a length of threaded pipe that forms water hose connector 12. The flat sheets for construction of fluid duct 11 and lower end 11b are cut to size and then folded into the requisite shapes. Orifices are formed along the side edges of fluid duct 11 during die cutting, stamping or the like for receipt of attachment means (not shown) to create a closed shape for fluid duct 11. Orifices are also formed along the lower edge of fluid duct 11 and lower end 11b during die cutting, stamping or the like for receipt of attachment means (not shown) for attaching lower end 11b to fluid duct 11. The length of threaded pipe forming water hose connector 12 is then inserted into the central opening of lower end 11b and secured thereto via attachment means such as, but not limited to, nuts. The orifices along the lower edge of fluid duct 11 are aligned with the orifices on lower end 11, and lower end 11 is attached to fluid duct 11 via attachment means such as, but not limited to, nuts or screws.

FIG. 2 is a front perspective view of an exemplary downspout attachable water-dispersing device 10 attached to a downspout 1 and a conventional water hose 2, in accordance with an embodiment of the present invention. In the present embodiment, an open upper end 11a of a downspout attachment section 11c of a fluid duct 11 is disposed around a lower end of downspout 1, which is attached to a building A. Water-dispersing device 10 may be fixedly attached to downspout 1 by various different conventional fastener means known in the art such as, but not limited to, bolts, screws, welding, adhesives, friction, etc. Conventional water hose 2 is attached to a water hose connector 12. Water hose 2 is preferably at least 10 feet to 25 feet long; however, hoses of any length may be used. Conventional water hoses typically comprise one open end with a female connector and another open end with a male connector. In the present embodiment, water hose connector 12 is a male connector; therefore, the end of water hose 2 with the female connector is threaded onto water hose connector 12. In alternate embodiments where the water hose connector is a female connector, the end of the hose with the male connector is threaded into the water hose connector.

In typical use of the present embodiment, a user slides open end 11a of water-dispersing device 10 onto downspout 1 and secures water-dispersing device 10 to downspout 1 with the desired fastener means. The user then connects water hose 2 to water hose connector 12. Once water hose 2 is connected to water hose connector 12, the user may place the open end of hose 2 opposite from the end attached to water hose connector 12 in the location where he would like the water from downspout 1 to be dispersed. This location is preferably a substantial distance away from downspout 1 and the foundation of building A. Water flowing through downspout 1 enters water-dispersing device 10 at open upper end 11a and exits at water hose connector 12 into water hose 2. The water is then dispersed from the open end of water hose 2. In an alternative use of the present embodiment, water hose 2 can be removed from water-dispersing device 10 to allow the downspout water to be dispersed near downspout 1 or to provide unobstructed clearance around downspout 1 for various purposes such as, but not limited to, cleaning, gardening or maintenance.

Since conventional water hose 2 can be connected to water-dispersing device 10, water from downspout 1 can be dispersed at a remote location from downspout 1. Furthermore, the flexibility of water hose 2 enables the user to selectively place the open end of water hose 2 at various different positions away from downspout 1. This generally eliminates problems of water pooling and the tendency for the ground to be washed away at the point where the downspout water is eventually deposited. Water-dispersing device 10 enables the user to selectively alter the place where the downspout water is eventually deposited. Thus, the downspout water can be deposited at a variety of different locations. In the present embodiment, water-dispersing device 10 is adaptable to grounds, lawns or surface areas of any size.

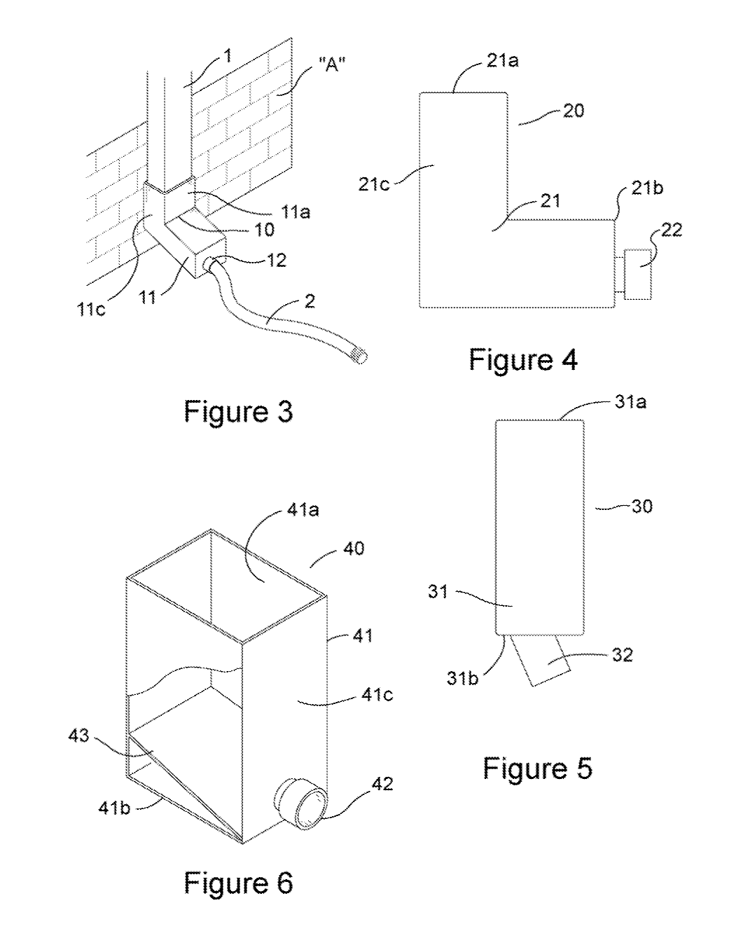

FIG. 3 is a diagrammatic side view of an exemplary right angle, downspout attachable water-dispersing device 20, in accordance with an embodiment of the present invention. In the present embodiment, downspout attachable water-dispersing device 20 comprises a fluid duct 21 and a water hose connector 22. Water hose connector 22 in downspout attachment water dispersing device 20 is shown as a female water hose adapter; however, a male adaptor may be used in alternate embodiments. In the present embodiment, fluid duct 21 is formed having a vertically disposed downspout connection section 21c and a water hose connector section 21d disposed at a 90-degree angle from downspout connection section 21c. As heretofore described, an upper end 21a of downspout connection section 21c is open to fit onto a downspout and a lower end 21b of water hose connector section 21d is closed except for the portion in communication with water hose connector 22.

FIG. 4 is a diagrammatic side view of an exemplary downspout attachable water-dispersing device 30, in accordance with an embodiment of the present invention. In the present embodiment, downspout attachable water-dispersing device 30 comprises a fluid duct 31 and a water hose connector 32. Fluid duct 31 is a straight member having an open upper end 31a and a closed lower end 31b. Water hose connector 32 is angularly disposed, preferably at approximately 115-degrees, from closed, lower end 31b of fluid duct 31. However, the hose connector may be attached to the fluid duct at various different angles in alternate embodiments.

FIG. 5 is a side perspective, partially cut away view of an exemplary downspout attachable water-dispersing device 40, in accordance with an embodiment of the present invention. In the present embodiment, downspout attachable water-dispersing device 40 comprises a straight fluid duct 41 having an open upper end 41a and a closed lower end 41b. A baffle plate 43 is angularly disposed within the interior of fluid duct 41 adjacent to lower end 41b thereof. A water hose connector 42 is disposed in a lower portion of a sidewall 41c of fluid duct 41. Baffle plate 43 guides water flowing through water-dispersing device 40 toward water hose connector 42 where it exits water-dispersing device 40.

Alternate embodiments of the present invention may comprise a specially designed water hose to attach to the water hose connector of the water-dispersing device. An example of such a water hose is formed substantially similarly to a conventional water hose having a length of flexible tubing with a female adapter disposed at one end of the flexible tubing and a male adapter disposed at the opposing end of the flexible tubing. However, the present water hose comprises a plurality of spray dispersion orifices formed adjacent to an end of the flexible tubing. The spray dispersion orifices permit downspout water dispersion to the sides of the water hose in addition to or in lieu of dispersion from the end of the water hose. Spray dispersion orifices may be formed in either the end of the flexible tubing adjacent to the female adapter or the end adjacent to the male adapter. However, it is preferred that the spray dispersion orifices are formed in the end of the flexible tubing that will not be connected to the water-dispersing device. Those skilled in the art, in light of the present teachings, will readily recognize that hoses in alternate embodiments may comprise various different features such as, but not limited to, a nozzle at the open end, a shut off valve, connectors for attaching additional hoses, self-coiling mechanisms, caps, etc.

While the foregoing embodiments of the present invention have been shown and described for downspout attachable water-dispersing devices having square or rectangular cross-sections, it should be readily understood by those skilled in the art that the devices in alternate embodiments may be constructed with a variety of different cross-sectional configurations such as, but not limited to, round configurations, semi-circular configurations, triangular configurations, etc.

Having fully described at least one embodiment of the present invention, other equivalent or alternative methods of providing a downspout water-dispersing device according to the present invention will be apparent to those skilled in the art. The invention has been described above by way of illustration, and the specific embodiments disclosed are not intended to limit the invention to the particular forms disclosed. For example, the particular implementation of the fluid duct may vary depending upon the particular type of water hose connection used. The water hose connections described in the foregoing were directed to single connector implementations; however, similar techniques are to provide multiple water hose connectors on a single fluid duct. For example, without limitation, the fluid duct may comprise multiple water hose connectors on the lower end or may comprise multiple water hose connector sections attached to a single downspout connection section. Multiple hose implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a fluid duct comprising a first portion having an open end and a second portion having a closed end where said first portion and said second portion form an angle, said fluid duct being configured for joining said open end to a downspout; and
a hose connector comprising a hollow passage way, said hose connector being joined to said second portion proximate said closed end where said hose connector forms a passage to an interior of said fluid duct enabling fluid in said fluid duct to pass to an exterior of said hose connector.

2. The apparatus as recited in claim 1, further comprising a baffle disposed within said fluid duct and being operable for diverting fluid away from said closed end and towards said hose connector.

3. The apparatus as recited in claim 2, in which said baffle forms an obtuse angle with a side of said fluid duct.

4. The apparatus as recited in claim 3, in which said hose connector is joined to a side of said fluid duct proximate said closed end.

5. The apparatus as recited in claim 1, in which said hose connector is joined to said closed end.

6. The apparatus as recited in claim 5, in which said hose connector forms an obtuse angle with a side of said fluid duct.

7. The apparatus as recited in claim 1, in which said hose connector is joined to said closed end below a horizontal mid-line of said closed end.

8. The apparatus as recited in claim 7, in which said angle formed by said first portion and said second portion is a right angle.

9. The apparatus as recited in claim 7, in which said angle formed by said first portion and said second portion is an obtuse angle.

10. The apparatus as recited in claim 1, in which a portion of said hose connector is threaded for joining to a hose.

11. The apparatus as recited in claim 10, in which said threaded portion is a male adapter for a garden hose.

12. An apparatus comprising:
means for joining to a downspout to disperse a fluid from the downspout; and
means for joining to a hose to enable fluid to pass from the means for joining to a downspout to the hose.

13. A system comprising:
a fluid duct comprising a first portion having an open end and a second portion having a closed end where said first portion and said second portion form an angle, said fluid duct being configured for joining said open end to a downspout;
a hose connector comprising a hollow passage way and a threaded exterior portion, said hose connector being joined to said second portion proximate said closed end where said hose connector forms a passage to an interior of said fluid duct enabling fluid in said fluid duct to pass to an exterior of said hose connector; and
a hose removably joined to said threaded exterior portion of said hose connector for dispersing the fluid away from the hose connector above a ground surface.

14. The system as recited in claim 13, further comprising a baffle disposed within said fluid duct to form an obtuse angle with a side of said fluid duct, said baffle being operable for diverting fluid away from said closed end and towards said hose connector.

15. The system as recited in claim 14, in which said hose connector is joined to a side of said fluid duct proximate said closed end.

16. The system as recited in claim 13, in which said hose connector is joined to said closed end below a horizontal mid-line of said closed end.

17. The system as recited in claim 16, in which said hose connector forms an obtuse angle with a side of said fluid duct.

18. The system as recited in claim 16, in which said angle formed by said first portion and said second portion is a right angle.

19. The system as recited in claim 16, in which said angle formed by said first portion and said second portion is an obtuse angle.

20. The system as recited in claim 13, in which said hose is a garden hose.
